(19) United States
(12) Patent Application Publication
(10) Pub. No.: US 2020/0056583 A1
(43) Pub. Date: Feb. 20, 2020

(54) AIRBORNE DEVICE

(71) Applicant: Institut Polytechnique de Grenoble, Grenoble (FR)

(72) Inventor: Rogelio LOZANO, Grenoble (FR)

(21) Appl. No.: 16/345,659

(22) PCT Filed: Oct. 24, 2017
(86) PCT No.: PCT/FR2017/052939

§ 371 Date: Apr. 26, 2019

(30) Foreign Application Priority Data
Oct. 31, 2016 (FR) 1660569

(51) Int. Cl. F03D 5/00; F03D 9/25; B64C 39/02; F03D 9/32

(52) U.S. Cl. CPC F03D 5/00; F03D 9/25; F05B 2240/921; F03D 9/32; B64C 39/022

(57) ABSTRACT

The presently disclosed subject matter relates to an airborne device that includes at least three airfoils and a linking device. The airfoils are connected together by first cables, each airfoil further being connected to the linking device by a second cable. The linking device being connected to a third cable intended for being connected to a base. The first, second and third cables being tensioned when the airborne device is placed in the wind. The device further includes for each airfoil, at least one first rigid lever element connected to the first cables and the airfoil by a first electromechanical linking system having at least one degree of rotational freedom and designed for modifying the orientation of the first lever element relative to the airfoil.

### CROSS REFERENCE TO RELATED APPLICATIONS

This application is a national phase filing under 35 C.F.R. § 371 of and claims priority to PCT Patent Application No. PCT/FR2017/052939, filed on Oct. 24, 2017, which claims the priority benefit under 35 U.S.C. § 119 of French Patent Application No. 1660569, filed on Oct. 31, 2016, the contents of each of which are hereby incorporated in their entireties by reference.

### BACKGROUND

The presently disclosed subject matter relates to an airborne device for converting the kinetic energy of wind into mechanical energy.

Airborne devices used to convert the kinetic energy of wind into mechanical energy generally include a kite or an aerostat. One advantage thereof is that such airborne devices can be used at high altitudes where winds are generally stronger and/or more constant than at lower altitudes.

The airborne device can be used to tow a vehicle, for example, a boat. The airborne device can be used to drive an electric power generator. The electric power generator can be carried by the airborne device or located on the ground. The airborne device thus forms an airborne wind turbine which enables the kinetic energy of the wind to be converted into electrical energy.

Patent application WO2016/012695 discloses an airborne device including at least three aerofoils and a linking device. The aerofoils are connected together by first flexible cables. Each aerofoil is furthermore connected to the linking device by a second flexible cable. The linking device is connected to a base on the ground by a third cable. The first, second and third cables are tensioned when the airborne device is placed in the wind.

One advantage of such an airborne device is that the device can have a reduced weight and dimensions when the aerofoils are not deployed, which eases the transport thereof whereas, during operation, the aerofoils can be separated from one another by a long distance so as to trace an outer circle of a large diameter that is greater than or equal to the outer circle traced by the blades of a conventional wind turbine.

One drawback of such an airborne device is that it can be difficult to accurately control the orientations of the aerofoils during operation.

### SUMMARY

One purpose of one embodiment aims at overcoming all or part of the drawbacks of the airborne devices described hereinabove used to convert the kinetic energy of wind into mechanical energy.

Another purpose of one embodiment is to provide the airborne device with a simple structure.

Another purpose of one embodiment is to be able to simply control the orientation of each aerofoil of the airborne device during operation.

Thus, another embodiment provides for an airborne device including at least three aerofoils and a linking device, the aerofoils being connected together by first cables intended to operate solely under traction, each aerofoil furthermore being connected to the linking device by a second cable intended to operate solely under traction, the linking device being connected to a third cable intended to be connected to a base, the first, second and third cables being tensioned when the airborne device is placed in the wind, the device further including, for each aerofoil, at least one first rigid lever element connected to at least one of the first cables and connected to the aerofoil by a first electromechanical linking system having at least one rotational degree of freedom and suitable for modifying the orientation of the first lever element relative to the aerofoil.

According to another embodiment, the first electromechanical linking system has at least two rotational degrees of freedom.

According to one embodiment, the first electromechanical linking system has at least two rotational degrees of freedom about axes that are perpendicular to one another to within 10%.

According to another embodiment, the first lever element includes at least one first tubular portion including first and second opposite ends, one of the first cables being connected to the first end.

According to one embodiment, the first lever element includes at least one second tubular portion having third and fourth ends, another of the first cables being connected to the third end, the first and second tubular portions being joined at the second and fourth ends, inclined relative to one another and connected to the first electromechanical linking system at the second and fourth ends.

According to another embodiment, the first tubular portion is rectilinear, another of the first cables being connected to the second end, the first tubular portion being connected at the central portion to the first electromechanical linking system.

According to one embodiment, the airborne device further includes, for each aerofoil, at least one second rigid lever element connected to one of the second cables and connected to the aerofoil by a second electromechanical linking system having at least one rotational degree of freedom and suitable for modifying the orientation of the second lever element relative to the aerofoil.

According to one embodiment, the second electromechanical linking system has at least two rotational degrees of freedom.

According to another embodiment, the second electromechanical linking system has at least two rotational degrees of freedom about axes that are perpendicular to one another to within 10%.

According to one embodiment, the airborne device does not include any rigid frame connecting the aerofoils to one another and moreover intended to be subjected to stresses other than tensile stresses.

According to another embodiment, each aerofoil is connected to at least two other aerofoils by at least two first cables.

According to one embodiment, the airborne device includes at least two pairs of aerofoils, the two aerofoils of each pair being connected to one another by one of the first cables, each aerofoil of each pair being connected to at least one of the aerofoils of the other pair by another one of the first cables.

According to another embodiment, the span of each aerofoil lies in the range 5 m to 50 m.

According to one embodiment, at least one of the aerofoils includes an extrados connected to an intrados by a leading edge, a trailing edge, and first and second side edges, and the first lever element is connected to the side edge of the aerofoil of the airborne device situated the furthest inwards when the airborne device is placed in the wind.

According to another embodiment, the second lever element is connected to the intrados of the aerofoil.

According to one embodiment, the first, second and third cables are flexible cables.

### BRIEF DESCRIPTION OF THE FIGURES

The foregoing and other features and advantages will be described in detail in the following non-limiting description of specific embodiments provided with reference to the accompanying figures, among which:

FIG. 1 is a partial, diagrammatic, perspective view of one embodiment of an airborne device;

FIG. 2 is a partial, diagrammatic, overhead view of one embodiment of an aerofoil of the airborne device shown in FIG. 1;

FIGS. 3 and 4 are a partial, diagrammatic perspective view and a partial, diagrammatic sectional view respectively, of a portion of the airborne device in FIG. 1, showing one embodiment of a lever element;

FIG. 5 is a partial, diagrammatic, perspective view of a portion of the airborne device in FIG. 1, showing another embodiment of a lever element;

FIGS. 6A, 6B and 6C are partial, diagrammatic, side views of embodiments of the arrangement of the cables between two lever elements as shown in FIG. 5;

FIG. 7 is a partial, diagrammatic, perspective view of a portion of the airborne device in FIG. 1, showing one embodiment of another lever element;

FIG. 8 is a partial, diagrammatic, side view of two aerofoils of the airborne device in FIG. 1, showing the control of the orientation of the aerofoils;

FIG. 9 is a perspective view with a partial cross-section of an aerofoil showing one embodiment of a system for controlling the inclination of the lever element shown in FIG. 3;

FIGS. 10A and 10B are more detailed perspective views, taken from two opposite directions, of one embodiment of the control system shown in FIG. 9;

FIG. 11 is a perspective view with a partial cross-section of an aerofoil showing one embodiment of a system for controlling the inclination of the lever element shown in FIG. 7;

FIGS. 12 and 13 are a partial, diagrammatic, perspective view and a partial, diagrammatic, front view respectively, of another embodiment of an aerofoil of the airborne device shown in FIG. 1;

FIG. 14 is a partial, diagrammatic, overhead view of another embodiment of an aerofoil of the airborne device shown in FIG. 1;

FIGS. 15 and 16 are partial, diagrammatic, sectional views of embodiments of a cable of the airborne device shown in FIG. 1;

FIG. 17 is a partial, diagrammatic, perspective view of a system for generating electricity including the airborne device shown in FIG. 1; and

FIG. 18 is a partial, diagrammatic, perspective view of a transport system including the airborne device shown in FIG. 1.

### DETAILED DESCRIPTION OF EXEMPLARY EMBODIMENTS

The same elements are denoted by the same reference numerals in the different figures. For clarity purposes, elements beneficial for understanding the embodiments described have been shown and described. Unless specified otherwise, the terms “approximately”, “substantially”, and “about” mean to within 10%, possibly to within 5%.

In the description below, the average cable diameter refers to the diameter of the circle that falls within the cross-section of the cable. If the cross-section of the cable is circular, the average cable diameter corresponds to the diameter of the cross-section of the cable. If the cross-section of the cable is profiled, the average cable diameter corresponds to the diameter of the circle that lies inside the profile, and is substantially equal to the thickness of the profile.

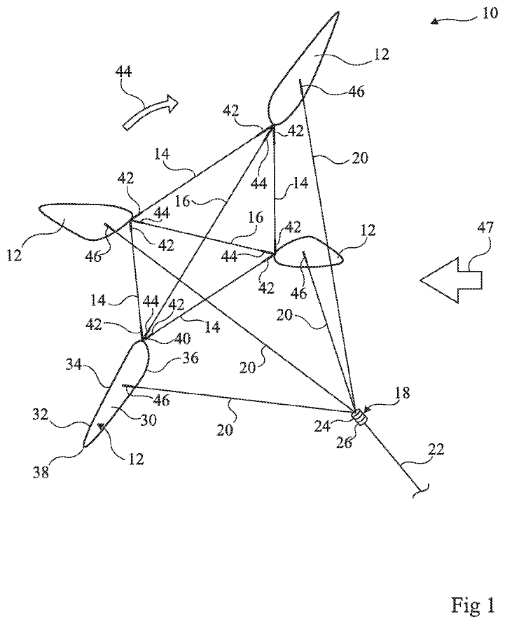

FIG. 1 shows one embodiment of an airborne device 10. The airborne device 10 includes at least three aerofoils, for example, from three to eight aerofoils 12. The airborne device may include at least four aerofoils 12. Advantageously, the airborne device 10 includes an even number of aerofoils 12. The aerofoils 12 are connected to one another by cables or beams 14, 16 intended to operate solely under traction when in operation. According to one embodiment, the cables 14, 16 are flexible cables. A flexible cable is a cable which can, under the action of an external force, become deformed, and in particular bend, without breaking or tearing. The minimum radius of curvature that can be applied to the cable without causing irreversible deformation can depend on the diameter of the cable. Generally speaking, a radius of curvature of greater than or equal to 3 m can be applied to the cable without causing irreversible deformation. For a cable having an average diameter of greater than or equal to 1.5 cm, a radius of curvature of greater than or equal to 1 m can be applied to the cable without causing irreversible deformation. For a cable having an average diameter of greater than or equal to 3 mm, a radius of curvature of greater than or equal to 30 cm can be applied to the cable without causing irreversible deformation. There is no linking frame subjected to stresses other than the tensile stresses, connecting the aerofoils 12 to one another. By way of example, in the case where the airborne device 10 includes four aerofoils 12, each aerofoil 12 is connected to each adjacent aerofoil by a flexible cable 14 and is connected to the opposite aerofoil by a flexible cable 16. Moreover, each aerofoil 12 is connected to a linking device 18 by a flexible cable 20. The linking device 18 is connected to an anchoring system, not shown, by a flexible cable 22. Depending on the application considered, the anchoring system can be on the ground, on a buoy, or on a ship. According to one embodiment, the linking device 18 includes a first portion 24 having the cables 20 attached thereto, and connected to a second portion 26 having the cable 22 attached thereto. The first portion 24 is suitable for pivoting relative to the second portion 26 about the axis of the cable 22. The linking device 18 can correspond to a swivel.

Each aerofoil 12 corresponds to an aerofoil including an intrados 30 connected to an extrados 32 by a leading edge 34, a trailing edge 36, an external side edge 38, directed towards the outside of the device 10, and an internal side edge 40, directed towards the inside of the device 10. Each aerofoil 12 can correspond to a profiled aerofoil, for example, having a NACA profile.

According to one embodiment, the device 10 includes, for each aerofoil 12 and for each cable 14, a lever element 42 connecting the aerofoil 12 to the cable 14. The device 10 further includes, for each aerofoil 12, a lever element 44 connecting the aerofoil 12 to the cable 16 if the cable 16 is present. The device 10 further includes, for each aerofoil 12, a lever element 46 connecting the aerofoil 12 to the cable 20. According to one embodiment, for each aerofoil 12, the lever elements 42 that connect the aerofoil 20 to the cables 14 are combined and form a single-piece lever element 42. Each aerofoil 12 further includes structure, not visible in FIG. 1, for modifying the inclination of each lever element 42, 44 and 46 relative to the aerofoil 12.

Each lever element 42, 44 and 46 is assembled on the aerofoil 12 by an electromechanical linking system not visible in FIG. 1. According to one embodiment, each lever element 42, 44 and 46 is assembled on the aerofoil 12 by an electromechanical linking system having at least one rotational degree of freedom, possibly by an electromechanical linking system having at least two rotational degrees of freedom. The electromechanical linking system can have no translational degree of freedom or can also have at least one translational degree of freedom.

Each lever element 42, 44 and 46 can have the overall shape of a tube that is potentially rectilinear, one end of the tube being connected to the aerofoil 12 and the associated cable extending from the opposite end of the tube.

According to one embodiment, each cable 14, 16 or 20 is fixed, at one end thereof, to the corresponding lever element 42, 44 and 46. Alternatively, for at least one of the cables 14, 16 or 20, a cylindrical aperture passes through the corresponding lever element 42, 44 and 46, inside of which aperture the associated cable extends, the end of the cable thus being capable of being fixed to a part contained in the aerofoil 12.

For each aerofoil 12, the lever elements 42 and 44 may be substantially connected to the same point of the internal side edge 40 of the aerofoil 12. Moreover, for each aerofoil 12, the lever element 46 may be connected to the aerofoil 12 at a point of the intrados 30 at a distance from the leading edge 34, from the trailing edge, from the external side edge 38 and from the internal side edge 40. Alternatively, the lever element 46 can be connected to the internal side edge 40.

The airborne device 10 operates as follows. Under wind load, as diagrammatically illustrated by the arrow 47, the aerofoils 12 are displaced under the effect of lift forces. Centrifugal forces tend to radially separate the aerofoils 12, such that the cables 14 and 16 are permanently tensioned. A rotational movement of the aerofoils 12 is thus obtained, which is shown in FIG. 1 by the arrow 48. The lift stresses exerted on each aerofoil 12 result in the traction of the cables 20, and thus in the traction of the cable 22. A conversion of the kinetic energy of the wind 47 into mechanical energy exerting traction on the cable 22 is thus obtained. The aerofoils 12 of the airborne device 10 rotate similarly to the blades of a wind turbine on the ground. The present embodiment is based on the fact that, for a conventional wind turbine on the ground, the blade portions that are, during operation, the most efficient for capturing the kinetic energy of wind, are situated close to the free ends of the blades, where the drive torque from the wind is the highest. The aerofoils 12 are thus situated in useful areas where the drive torque from the wind 47 is the highest and the cables 14, 16, 20 are situated in areas where the drive torque from the wind 47 is low. The surface area covered by the aerofoils 12 during the movement thereof can thus be extensive, even though the airborne device has a simple structure and a low weight.

The maximum diameter during operation of the airborne device 10 may lie in the range 20 m to 200 m, possibly in the range 100 m to 150 m. The weight of the airborne device 10, not including the cable 22, can lie in the range 20 kg to 20 tons. The rotational speed during operation of the aerofoils can lie in the range 1.5 to 200 revolutions per minute.

During the rotation of the aerofoils 12, the inclinations of the lever elements 42, 44 and/or 46 can be modified. This results in a modification of the stresses exerted on the cables 14, 16 and/or 20, which results in a modification of the relative orientations and positions of the aerofoils 12 relative to one another.

The use of the lever elements 42 and 44 advantageously allows, for each aerofoil 12, the cables 14, 16 to apply, to the aerofoil 12, an overall tensile force in an axis that substantially intersects the centre of gravity of the aerofoil 12. This improves the aerodynamic performance of the aerofoil 12 compared to an aerofoil for which a modification of the orientation of the aerofoil is obtained solely by ailerons provided on the aerofoil. More specifically, in the latter case, the actuation of the ailerons can result in the cables 14, 16 applying, to the aerofoil 12, an overall tensile force in an axis that does not intersect the centre of gravity of the aerofoil 12, which generates torque that works to align the aerofoil 12 with the axis of the overall tensile force of the cables. This results in possibly requiring the ailerons to be actuated at all or most times in order to maintain a modified orientation of the aerofoil, which results in lower performance from an aerodynamic perspective.

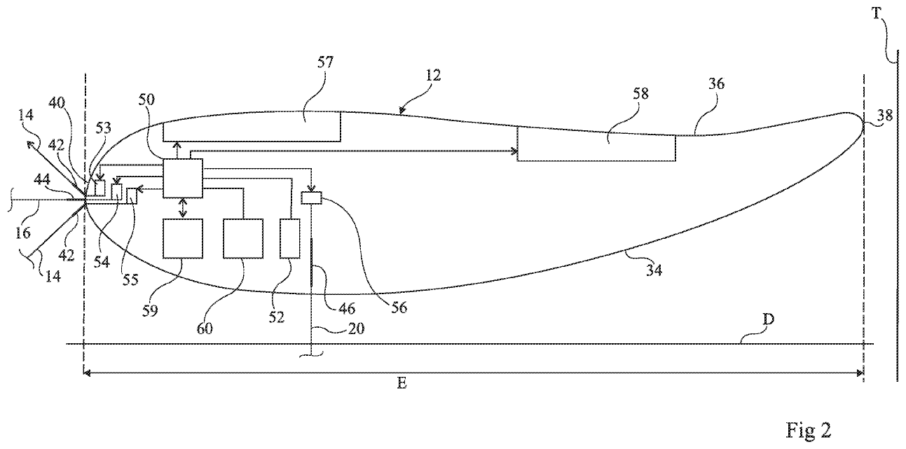

FIG. 2 is a diagrammatic view of one embodiment of one of the aerofoils 12 of the airborne device 10 shown in FIG. 1. Each aerofoil 12 of the airborne device 10 can have substantially the structure shown in FIG. 4. The aerofoil 12 forms a partially hollow enclosure and a plurality of elements arranged in the internal volume of the aerofoil 12 are diagrammatically shown in FIG. 4. The aerofoil 12 is, for example, made of composite materials. The cables 14, 16, 20 can be made of synthetic fibres, particularly the product marketed under the trade name Kevlar. Each cable 14, 16, 20 has an average diameter that lies in the range 3 mm to 15 cm. The lever elements 42, 44, 46 can be made of synthetic fibres, for example of carbon fibres or Kevlar.

In the description hereafter, the longitudinal axis D of the aerofoil designates an axis that is perpendicular to the two most distant parallel planes, one of which is tangent to the external side edge 38 and the other being tangent to the internal side edge 40. The span E of the aerofoil 12 is the distance between these planes. The span E lies in the range 5 m to 50 m, possibly in the range 25 m to 35 m. Moreover, a transverse axis T of the aerofoil designates an axis in a plane that is perpendicular to the longitudinal axis D and that extends between the front leading edge and the rear leading edge of the aerofoil. The chord of the aerofoil 12, measured in a plane perpendicular to the longitudinal axis D, can be non-constant along the axis D. According to one embodiment, the chord increases from the internal side edge 40 to a maximum chord, and then decreases until it reaches the external side edge 38. The maximum chord lies in the range 0.25 m to 5 m, possibly in the range 1.25 m to 3.5 m. The maximum chord is substantially located between 10% and 45%, possibly between 15% and 30%, of the span from the internal side edge 40. At 50% of the span from the internal side edge 40, the ratio of the chord to the maximum chord lies in the range 60% to 100%, possibly in the range 70% to 90%. The maximum thickness between the extrados and the intrados lies in the range 7% to 25% of the value of the chord at this location, possibly in the range 8% to 15% of the value of the chord at this location. The aerofoil 12 can include a twist, i.e. the angle between the chord and a reference plane, or pitch angle, can vary along the axis D.

The aerofoil 12 includes:

a control module 50, for example including a processor;

sensors 52, connected to the control module 50, for example a speed sensor, an aerofoil position sensor, for example a GPS (Global Positioning System), gyroscopes, accelerometers, a Pitot tube, magnetometers, and a barometer;

electromechanical linking systems 53, 54, 55, 56, each system 53, 54, 55, 56 being controlled by the control module 50 and being connected to one of the lever elements 42, 44, 46;

at least one mobile trailing edge aileron, two mobile ailerons 57, 58 being shown in FIG. 4;

a remote communication module 59 connected to the control module 50; and

a storage battery 60 for powering the control module 50, the drive systems 53, 54, 55, 56, and the actuating motors of the ailerons 57, 58.

Alternatively, the battery 60 can be replaced with an electric power generator. Alternatively, the electrical energy for powering the control module 50, the actuating motors 53, 54, 55, 56 of the lever elements 42, 44, 46 and the actuating motors of the ailerons 57, 58 can be conveyed to each aerofoil via the cables 20 and 22.

Each drive system 53, 54, 55, 56 is suitable for modifying the inclination of the corresponding lever element 42, 44, 46 relative to the aerofoil 12.

According to one embodiment, the control module 50 of each aerofoil 12 is suitable for remotely exchanging signals, via the communication module 59, with the control modules 50 of the other aerofoils 12, for example according to a high-frequency type remote data transmission method. The control module 50 of each aerofoil 12 can furthermore be suitable for remotely exchanging signals, via the communication module 59, with a ground station.

The control of the incidence and/or roll of each aerofoil 12 is carried out by the control module 50 by modifying the inclination of the ailerons 57, 58 and by modifying the inclination of the lever elements 42, 44, 46, the cables 14, 16, 20 remaining tensioned during operation between the aerofoils 12 or between the aerofoils 12 and the linking device 18. According to one embodiment, the incidence of each aerofoil 12 can be cyclically modified during a revolution of the aerofoil 12. According to another embodiment, in the case where the airborne device 10 is connected to an electric power generator 46, the operation of the electric power generator 46 can include an alternation of first and second phases. In each first phase, the incidences of the aerofoils 12 are controlled to increase the tensile stresses exerted by the airborne device 10, the airborne device 10 moving away from the electric power generator 46. In each second phase, the incidences of the aerofoils 12 are controlled to decrease the tensile stresses exerted by the airborne device 10 on the cable 22 so as to be able to bring airborne device 10 closer to the generator 46 while consuming as little energy as possible.

According to one embodiment, the ailerons 57, 58 can be absent. The control of the incidence and/or of the roll of each aerofoil 12 is thus carried out by the control module 50 by modifying the inclination of the lever elements 42, 44, 46. The presence of the ailerons 57, 58 can, however, be advantageous. More specifically, they can provide for a faster modification of the incidence and/or roll of the aerofoils 12.

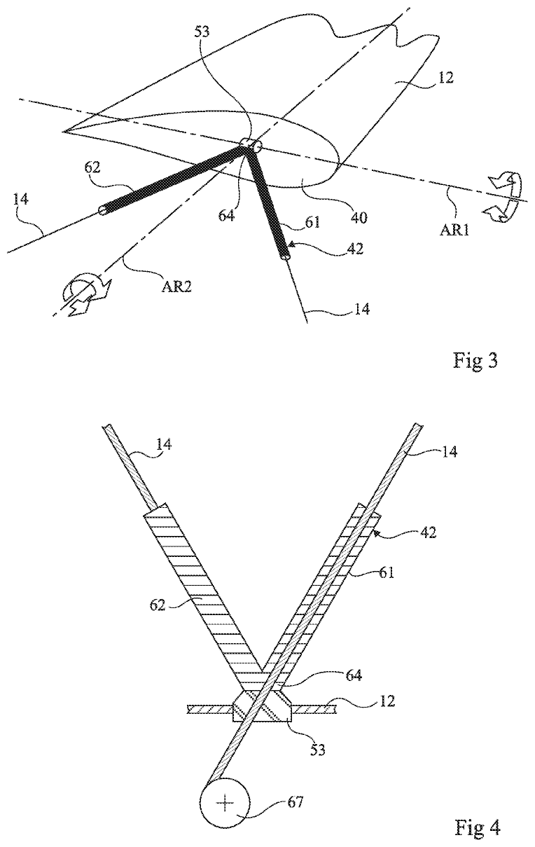

FIGS. 3 and 4 are a partial, diagrammatic, perspective view and a partial, diagrammatic, sectional view respectively, of a portion of the airborne device 10 shown in FIGS. 1 and 2, and showing one embodiment of the lever element 42.

In this embodiment, the lever element 42 has an overall V-shape including two branches 61 and 62, for example tubular and rectilinear in shape, joined at one end 64 connected to the internal side edge 40 of the aerofoil 12 by the electromechanical linking system 53. According to one embodiment, the angle between the two branches 61 and 62 lies in the range 66° to 150°, and in particular depends on the number of aerofoils 12. The length of each branch 62, 62 can lie in the range 50 cm to 5 m.

The electromechanical linking system 53 includes at least two rotational degrees of freedom about axes AR1 and AR2. One of the cables 14 is connected to the end of the branch 61 opposite the electromechanical linking system 53 and the other cable 14 is connected to the end of the branch 62 opposite the electromechanical linking system 53. As shown in FIG. 4, in this embodiment, one of the cables 14 is fixed inside the branch 62 at the end of the branch 62 opposite the electromechanical linking system 53 and the other cable 14 can slide in the branch 61, the end of the cable 14 being connected to an actuator 67 contained within the aerofoil 12. The actuator 67 is suitable for modifying the length of the tensioned portion of the cable 14 outside the aerofoil 12. According to another embodiment, each cable 14 is fixed to the end of the corresponding branch 61, 62. The tensioned portion of the cable 14 outside the aerofoil 12 is thus constant.

According to one embodiment, the rotational axes AR1 and AR2 are substantially perpendicular. The axis AR1 can be parallel to the transverse axis T of the aerofoil 12. The rotational axis AR2 can be parallel to the longitudinal axis D of the aerofoil 12. The aerofoil 12 contains drive systems, not visible in FIGS. 3 and 4, suitable for independently causing the lever element 42 to pivot about the axis AR1 and about the axis AR2.

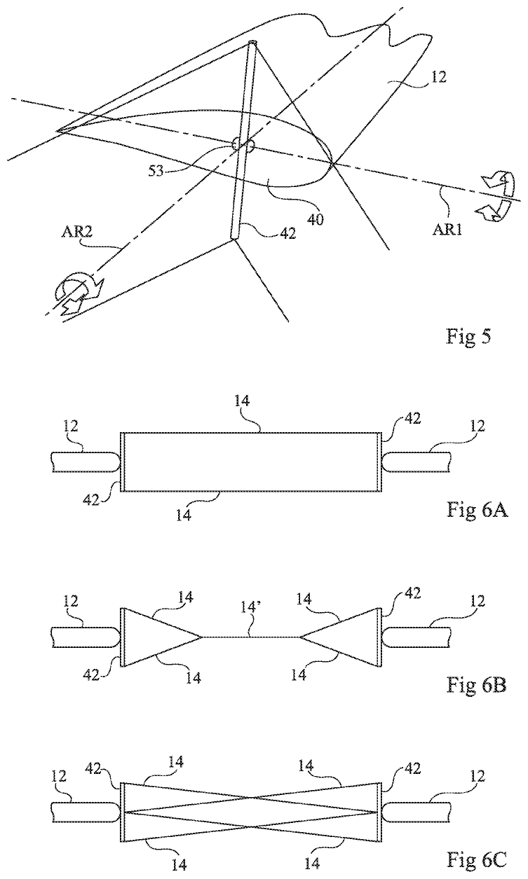

FIG. 5 is a partial, diagrammatic, perspective view of a portion of the airborne device 10 shown in FIGS. 1 and 2, and showing another embodiment of the lever element 42.

In the present embodiment, the lever element 42 has the overall shape of a rectilinear tube substantially connected, at the central portion thereof, to the internal side edge 40 of the aerofoil 12 by an electromechanical linking system 56. According to one embodiment, the length of the tube lies in the range 50 cm to 3 m. The electromechanical linking system 56 includes at least two rotational degrees of freedom about the axes AR1 and AR2 described hereinabove. In the present embodiment, the link between the aerofoil 12 and an adjacent aerofoil 12 is produced by first and second cables 14, a first cable 14 being connected to a first end of the tube 42 and a second cable 14 being connected to the second end of the tube 42. At least two cables 14 are thus connected to each end of the tube, which cables extend towards two different aerofoils 12.

In the embodiments described hereinabove with reference to FIGS. 3 and 5, a pivoting of the lever element 42 about the axis AR1 causes, by reaction, a modification to the stresses exerted by the cables 14 on the lever element 42 and thus to the torque exerted by the lever element 42 on the aerofoil 12 about the axis AR1. This causes a modification to the angle of inclination of the longitudinal axis D of the aerofoil 12 relative to a reference plane, for example a plane passing through the centre of mass of all or most of the aerofoils, and hereafter referred to as the roll angle of the aerofoil 12. Moreover, a pivoting of the lever element 42 about the axis AR2 causes, by reaction, a modification to the stresses exerted by the cables 14 on the lever element 42 and thus to the torque exerted by the lever element 42 on the aerofoil 12 about the axis AR2. This causes a modification to the angle of inclination of the transverse axis T of the aerofoil 12 relative to the reference plane, hereafter referred to as the pitch angle of the aerofoil 12.

FIGS. 6A, 6B and 6C show partial, diagrammatic views of the embodiments of the arrangement of the cables 14 between first and second lever elements 12 of the type shown in FIG. 5. In FIG. 6A, the cables 14 are substantially parallel. In FIG. 6B, for each lever element 42, the two cables 14 connected to the two ends of the lever element 42 are joined to form a single cable 14′. The arrangement in FIG. 6B reduces the torque induced by the inclination of the first lever element 42 on the second lever element 42, and vice-versa, compared to the arrangement shown in FIG. 6A. In FIG. 6C, the two cables 14 connected to the two ends of the first lever element 42 are fixed to the central portion of the second lever element 42, and the two cables 14 connected to the two ends of the second lever element 42 are fixed to the central portion of the first lever element 42. The arrangement in FIG. 6C advantageously substantially eliminates the torque induced by the inclination of the first lever element 42 on the second lever element 42, and vice-versa.

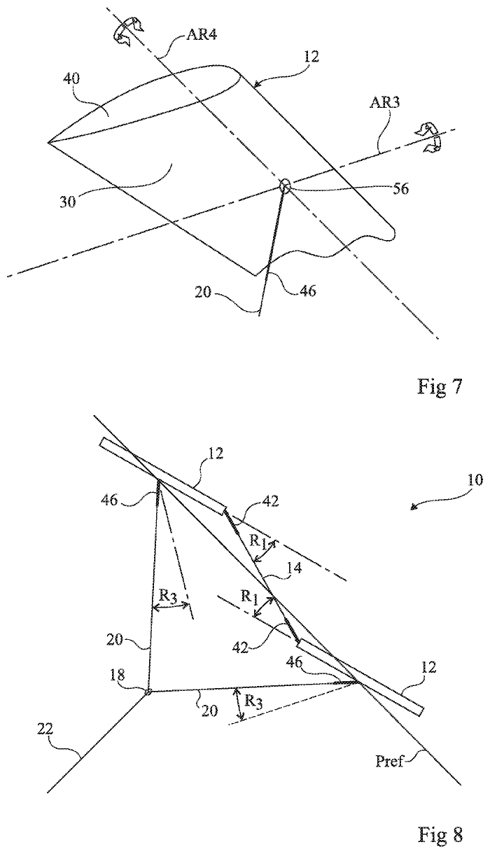

FIG. 7 is a partial, diagrammatic, perspective view of a portion of the airborne device 10 shown in FIGS. 1 and 2, and showing one embodiment of the lever element 46.

In the present embodiment, the lever element 46 has the overall shape of a rectilinear tube connected, at one end, to the intrados 30 of the aerofoil 12 by a link 70. The link 70 includes at least two rotational degrees of freedom about axes AR3 and AR4. The cable 20 is connected to the end of the lever element 46 opposite the link 70. According to one embodiment, the cable 20 is fixed to the end of the lever element 46. Alternatively, the cable 20 can slide in the lever element 46.

According to one embodiment, the rotational axes AR3 and AR4 are substantially perpendicular. The axis AR3 can be parallel to the transverse axis T of the aerofoil 12. The rotational axis AR4 can be parallel to the longitudinal axis D of the aerofoil 12. The aerofoil 12 contains drive systems, not visible in FIG. 3, suitable for independently causing the lever element 46 to pivot about the axis AR3 and about the axis AR4. According to one embodiment, the length of the lever element 46 lies in the range 50 cm to 5 m.

A pivoting of the lever element 46 about the axis AR3 causes, by reaction, a modification to the stresses exerted by the cable 20 on the lever element 46 and thus to the torque exerted by the lever element 46 on the aerofoil 12 about the axis AR3. This results in a modification to the roll angle of the aerofoil 12. Moreover, a pivoting of the lever element 46 about the axis AR4 causes, by reaction, a modification to the stresses exerted by the cable 20 on the lever element 46 and thus to the torque exerted by the lever element 46 on the aerofoil 12 about the axis AR4. This results in a modification to the pitch angle of the aerofoil 12.

FIG. 8 is a partial, diagrammatic, side view of two aerofoils 12 of the airborne device 10 showing one embodiment of the control of the roll angle of the aerofoils 12 during operation. The roll angle of each aerofoil 12 relative to the reference plane Pref is controlled by setting the angles R1 of rotation of each lever element 42 about the axis AR1 and the angles R3 of rotation of each lever element 46 about the axis AR3.

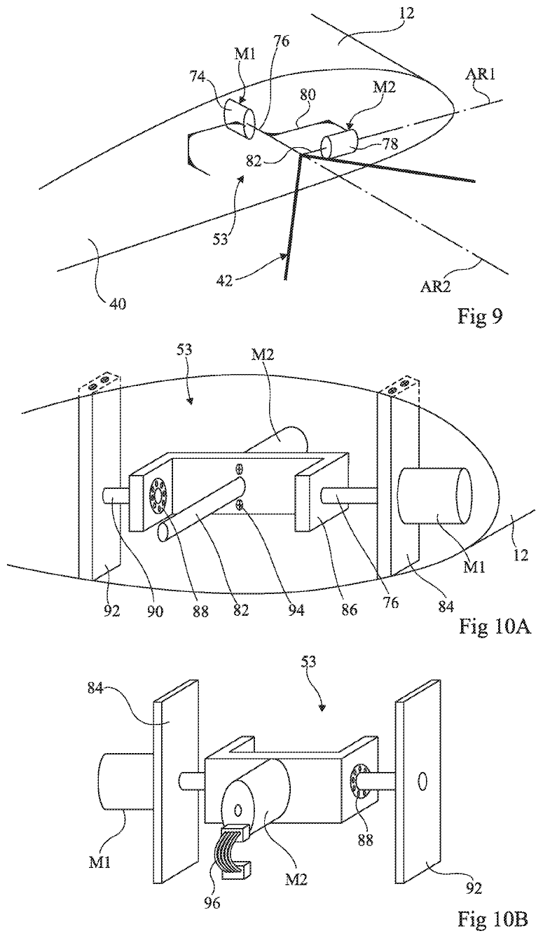

FIG. 9 is a perspective view with a partial cross-section of an aerofoil 12 in which one embodiment of the electromechanical linking system 53 driving the lever element 42 is shown by way of a kinematic drawing. In the present embodiment, the electromechanical linking system 53 includes a first motor M1, the casing 74 whereof is fixed to the frame of the aerofoil 12 and suitable for driving a shaft 76 in rotation about the axis AR2. The electromechanical linking system 53 further includes a second motor M2, the casing 78 whereof is fixed to the rotating shaft 76 by a rigid deflecting device 80 and suitable for driving a shaft 82 in rotation about the axis AR1. The lever element 42 is fixed to the shaft 82 substantially at the intersection of the shaft 82 with the axis AR2.

FIGS. 10A and 10B are more detailed perspective views, taken from two opposite directions, of one embodiment of the electromechanical linking system 53 shown in FIG. 9. The motor M1 is fixed by a first frame element 84 to the aerofoil 12 (which aerofoil 12 is not shown in FIG. 10B). The rigid deflecting device 80 includes a U-shaped part 86, one branch whereof is fixed to the shaft 76 of the first motor M1. The other branch of the part 86 is mounted such that it pivots, by a bearing 88, about a shaft 90 secured to a second frame element 92 fixed to the aerofoil 12. The second motor M2 is fixed to the part 86, for example by screws 94, such that the rotating shaft 82 intersects the axis AR2. The connection of the second motor M2 with the control module 50 can be produced by a flexible ribbon cable 96.

FIG. 11 is a perspective view with a partial cross-section of an aerofoil 12 in which one embodiment of the electromechanical linking system 56 of the lever element 46 is shown by way of a kinematic drawing. In the present embodiment, the electromechanical linking system 56 includes a first motor M3, the casing 98 whereof is fixed to the frame of the aerofoil 12 and suitable for driving a shaft 99 in rotation about the axis AR3. The electromechanical linking system 56 further includes a second motor M4, the casing 100 whereof is connected to the rotating shaft 99 by a pivot link 101 pivoting about an axis parallel to the axis AR4. The motor M4 is suitable for driving a shaft 102 in rotation. The shaft 102 rotates an auger of a helical link 103. The element of the helical link 103 capable of moving in translation is connected, via a pivot link 104, the axis whereof is parallel to the axis AR4, to one end of the lever element 46. The lever element 46 is furthermore connected by a pivot link 106 of axis AR4 to the shaft 76 of the first motor M1. The pivot link 106 is situated substantially on the axis AR3.

Alternatively, the actuating system 53 of the lever element 42 can also have the structure of the actuating system 56 as shown in FIG. 11. Moreover, the actuating system 54 of the lever element 44 can have the structure of the actuating system 53 or of the actuating system 56 described hereinabove.

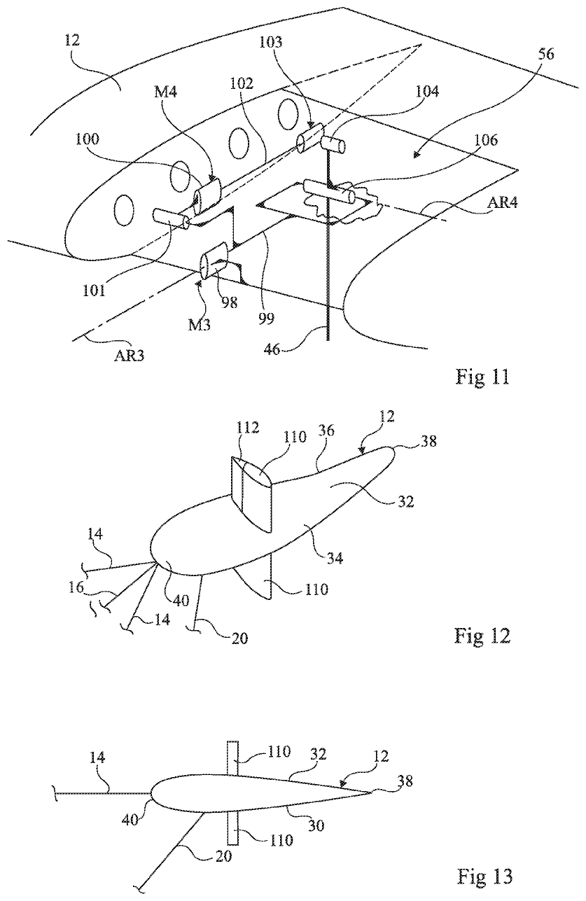

FIGS. 12 and 13 show another embodiment of the aerofoil 12 wherein the aerofoil 12 further includes two stabilisers 110 which can each include a mobile flap 112. The first stabiliser 110 protrudes from the extrados 32 and the second stabiliser 110 projects from the intrados 30. The actuation of the mobile flap 112 of each stabiliser 110 is controlled by the control module 50. The actuation of the mobile flap 112 in particular enables the lateral position of the airborne device 10 relative to the wind 47 to be controlled.

Each aerofoil 12 can be provided with a propulsion system. Before launching the airborne device 10, the aerofoils 12 can be arranged on a support. The propulsion system of each aerofoil 12 can be actuated. This causes the tensioning of the cables 14, 16, and the rotation of the aerofoils 12. Under the action of the lift stresses, the airborne 10 device rises into the air. As soon as the airborne device 10 is exposed to a sufficient wind to maintain the altitude and the rotation of the airborne device 10, the propulsion systems of the aerofoils 12 can be deactivated. The propulsion systems can furthermore be actuated in flight, while the airborne device 10 is at its operating altitude, if the wind power 47 is not sufficient to maintain the airborne device 10 at this altitude.

In the case wherein the tensioned portion of the cables 14 and 16 between the aerofoils 12 can be modified, when the airborne device 10 is lifted from the ground up to an operating altitude, the tensioned portions of the cables 14, 16, 20 between the aerofoils 12 or between the aerofoils 12 and the linking device 18 can be initially decreased in order to reduce the overall dimensions of the airborne device 10.

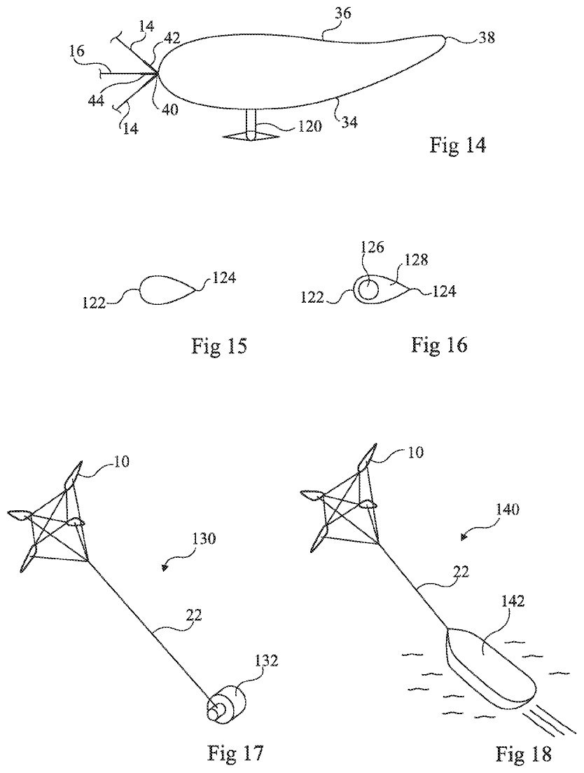

FIG. 14 shows one embodiment of the aerofoil 12, wherein the aerofoil propulsion system includes a motor-driven propeller 120 which projects from the leading edge 34 of the aerofoil to the front of the aerofoil in the rotation direction of the aerofoil 12 during operation. The motor-driven propeller 120 can be controlled by the control module 50 or can be remotely controlled from a ground station. One advantage of using a motor-driven propeller is that it furthermore enables the centre of gravity of the aerofoil 12 to be moved forwards in the direction of rotation of the aerofoil 12 during operation. This can be advantageous for improving the stability of the aerofoil. According to one embodiment, the propeller 120 can be removable and at least partially folded into the aerofoil 12 when it is not being used. Alternatively, the propulsion system can include a jet engine, particularly a rocket engine or a compressed air propulsion system.

Each aerofoil 12 can further include a landing gear, not shown, which allows the aerofoil 12 to be moved on the ground. The landing gear can be removable in order to be at least partially folded into the aerofoil 12 when it is not being used.

FIG. 15 shows one embodiment wherein each cable 14, 16, 20, or 22 or at least one of the cables 14, 16, 20, or 22 has a profiled section including a leading edge 122 and a thinned trailing edge 124. This in particular reduces the cable drag. Similarly, each lever element 42, 44, 46 can have a profiled section including a leading edge and a thinned trailing edge. This in particular reduces the drag of the lever element.

FIG. 16 shows one embodiment wherein each cable 14, 16, 20, or 22 or at least one of the cables, 14, 16 or 30 further includes a core 126 contained within a profiled casing 128. The core 126 can be made of a first material and the casing 128 can be made of a second material, the density of the first material being greater than the density of the second material. This enables the centre of gravity of the cable to be brought closer to the leading edge and thus improve the aerodynamic stability of the cable.

FIG. 17 shows one embodiment of an electric power generation system 130 wherein the cable 22 of the airborne device 10 is connected to an electric power generator 132. Alternatively, each aerofoil 12 can include an electric power generator including a turbine driven during the displacement of the aerofoil 12. The electrical energy generated can then be transmitted to the ground by the cables 20 and 22.

FIG. 18 shows one embodiment of a transport system 140 wherein the cable 22 of the airborne device 10 is connected to a vehicle 132, in this example to a ship. The airborne device 10 is thus used for towing the vehicle 142.

Various embodiments with different variations have been described hereinabove. It should be noted that a person skilled in the art can combine various elements of these embodiments and variations without showing any inventive step. In particular, the airborne device 10 can both include a propulsion system, such as the propeller 120 shown in FIG. 14, profiled cables 14, 16, 20 as shown in FIGS. 15 and 16, and a landing gear.

1. An airborne device, comprising:
at least three aerofoils and a linking device wherein
the aerofoils being connected together by first cables intended to operate solely under traction, each aerofoil furthermore being connected to the linking device by a second cable intended to operate solely under traction, and
the linking device being connected to a third cable intended to be connected to a base, the first, second and third cables being tensioned when the airborne device is placed in the wind,
wherein each of the aerofoils have at least one first rigid lever element connected to at least one of the first cables and connected to the aerofoil by a first electromechanical linking system having at least one rotational degree of freedom and suitable for modifying the orientation of the first lever element relative to the aerofoil.

2. The airborne device according to claim 1, wherein the first electromechanical linking system has at least two rotational degrees of freedom.

3. The airborne device according to claim 2, wherein the first electromechanical linking system has at least two rotational degrees of freedom about axes that are perpendicular to one another to within 10%.

4. The airborne device according to claim 1, wherein the first lever element includes at least one first tubular portion having first and second opposite ends, one of the first cables being connected to the first end.

5. The airborne device according to claim 4, wherein the first lever element has at least one second tubular portion having third and fourth ends, another of the first cables being connected to the third end, and the first and second tubular portions being joined at the second and fourth ends, inclined relative to one another and connected to the first electromechanical linking system at the second and fourth ends.

6. The airborne device according to claim 4, wherein the first tubular portion is rectilinear, another of the first cables being connected to the second end, and the first tubular portion being connected, at the central portion thereof, to the first electromechanical linking system.

7. The airborne device according to claim 1, further comprising, for each aerofoil:
at least one second rigid lever element connected to one of the second cables and connected to the aerofoil by a second electromechanical linking system having at least one rotational degree of freedom and suitable for modifying the orientation of the second lever element relative to the aerofoil.

8. The airborne device according to claim 7, wherein the second electromechanical linking system has at least two rotational degrees of freedom.

9. The airborne device according to claim 8, wherein the second electromechanical linking system has at least two rotational degrees of freedom about axes that are perpendicular to one another to within 10%.

10. The airborne device according to claim 1, not including any rigid frame connecting the aerofoils to one another and moreover intended to be subjected to stresses other than tensile stresses.

11. The airborne device according to claim 1, wherein each aerofoil is connected to at least two other aerofoils by at least two first cables.

12. The airborne device according to claim 1, further comprising at least two pairs of aerofoils, the two aerofoils of each pair being connected to one another by one of the first cables, each aerofoil of each pair being connected to at least one of the aerofoils of the other pair by another one of the first cables.

13. The airborne device according to claim 1, wherein the span of each aerofoil lies in the range of 5 m to 50 m.

14. The airborne device according to claim 1, wherein at least one of the aerofoils has an extrados connected to an intrados by a leading edge, a trailing edge, and first and second side edges, and wherein the first lever element is connected to the side edge of the aerofoil of the airborne device situated the furthest inwards when the airborne device is placed in the wind.

15. The airborne device according to claim 14, further comprising, for each aerofoil:
at least one second rigid lever element connected to one of the second cables and connected to the aerofoil by a second electromechanical linking system having at least one rotational degree of freedom and suitable for modifying the orientation of the second lever element relative to the aerofoil,
wherein the second lever element is connected to the intrados of the aerofoil.

16. The airborne device according to claim 1, wherein the first, second and third cables are flexible cables.

17. The airborne device according to claim 14, wherein the first electromechanical linking system further includes at least two rotational degrees of freedom about axes that are perpendicular to one another to within 10%.
